(19) United States
(12) Patent Application Publication
(10) Pub. No.: US 2004/0093346 A1
(43) Pub. Date: May 13, 2004

(54) Interactive education data support system

(76) Inventor: Gary Hochman, Jericho, NY (US)

Correspondence Address: SCHWEITZER CORNMAN GROSS & BONDELL LLP, 292 Madison Avenue, New York, NY, 10017, US

(21) Appl. No.: 10/697,189

(22) Filed: Oct. 30, 2003

Related U.S. Application Data
(60) Provisional application No. 60/422,597, filed on Oct. 31, 2002.

(51) Int. Cl. G06F 7/00

(52) U.S. Cl. 707/102

(57) ABSTRACT

An interactive education support system utilizes a student identification database to provide a secure environment for the collection, storage and controlled dissemination of graded materials. A unique student identification is affixed to a gradable material, such as a test. The identifier may be affixed to the material either before or after it is disseminated to the student associated with the identifier, who enters his or her work on the material, after which the material is collected and reviewed, the educator placing review data, such as a grade and/or comments, on the material. An image of the reviewed material is captured and stored in a database and is associated with at least the unique student identifier. The original material may then be returned to the student. The stored image can be accessed in a controlled manner by electronic means, such as through the Internet, by individuals such as the student's parents, guardians and/or school administrators, whereby the integrity of the original reviewed document is preserved.

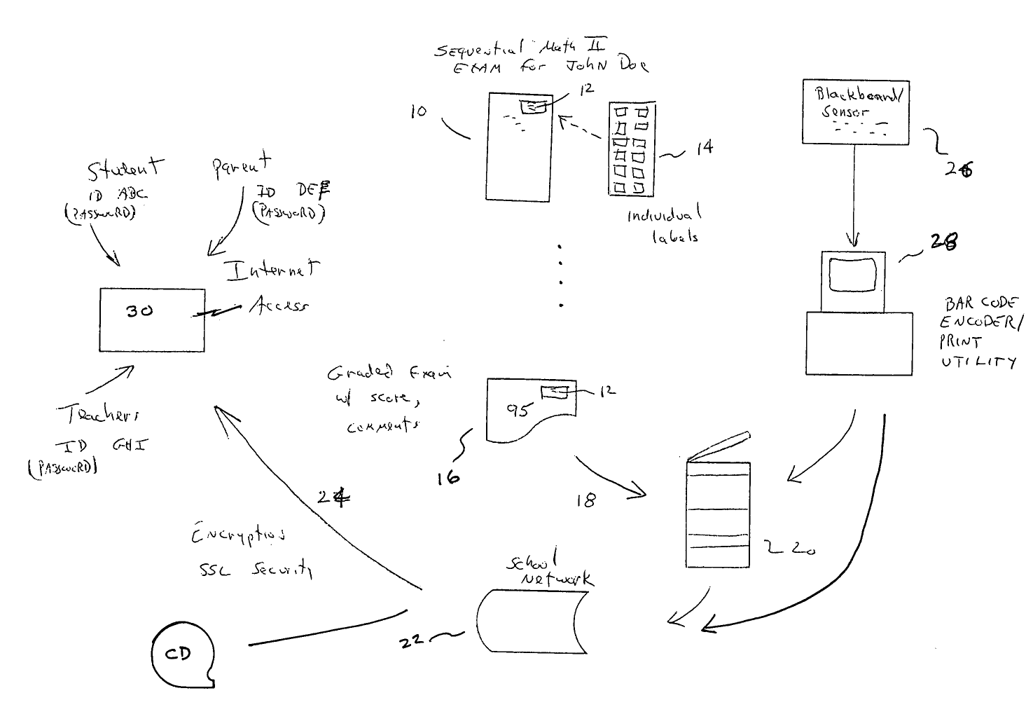

The present invention relates to a new and improved method and apparatus for the capture, storing and sharing of information in an educational environment. This application claims the priority of Provisional Application Serial No. 60/422,597 of Oct. 31, 2002.

### BACKGROUND OF THE INVENTION

It is well recognized that the Internet provides a platform through which information can be accessed and shared on a broad basis. Utilizing known protocols, such sharing can be undertaken in a generally secure manner. While use of the Internet has been made by educational facilities and organizations for the dissemination of assignments, research information and student-teacher correspondence through email, the full benefits of access to information by a remotely-situated user has yet to be fully appreciated or developed.

In both public and private school environments it is well recognized and appreciated that parent or guardian participation in, and knowledge of, the student's educational experience is important for student growth and effective learning. All too often, however, the parent or guardian is ill informed of matters concerning the student's education, especially when it comes to daily testing, the dissemination and maintenance of work materials, and grade performance and measurement. For example, the parent or guardian is often unaware of grades received by the student on a daily basis, whether on tests or exams or on graded or reviewed homework assignments. The traditional methods by which such information is transmitted to the parent or guardian, through verbal report by the student him- or herself, or by the presentation of a graded document to the parent or guardian by the student, leaves much to be desired. Often a poor grade or a poor performance is hidden or simply discarded by a student instead of it being used as a learning tool to correct a weakness of the student. Papers are lost, oral reports may be inaccurate and, of course, there may be simply a complete lack of disclosure. Thus, the parent or guardian may receive little, if any, information on the student's ongoing educational activities and performance, or may receive a highly biased, skewed, false or incomplete impression of what is occurring.

It is accordingly a purpose of the present invention to provide a secure methodology by which reviewing and grading information may be generated by an authorized source, such as a teacher grading a test paper of a student, wherein the resulting material, which may include hand written markings, such as comments, thereon as well as a grade marking, can be archived and viewed in a secure manner by an remote authorized recipient, such as a parent, guardian or school administrator.

It is further a purpose of the present invention to provide such a system which utilizes a secure computer network and the Internet.

### BRIEF DESCRIPTIONS OF THE INVENTION

In accordance with the foregoing and other objects and purposes, an interactive educational document support system in accordance with the present invention utilizes a student database that assigns or associates a unique identification code or other identifier to each student. Materials that are disseminated to the students, such as worksheets, tests, essays, quizzes, etc. are returned and reviewed by the teacher in a conventional manner. The student's identifier is associated with the returned material, such as via a pre-printed label which is attached before dissemination or printed or incorporated into the document itself in accordance with a pre-established format, or by being placed on the material by the teacher when the material is being reviewed. The material, which now includes the grade assigned by the teacher thereto as appears on the material along with any notes or annotations applied by either the student and/or teacher and the student's identifier, is optically scanned and saved in an image format on an appropriate database or document management system maintained by or for the educational facility. The label may be of a format that includes a barcode or similar coding that coordinates and identifies the student via the database's student identifier and includes other related information, such as course number, type of test, subject matter, etc. and a mark recognition section where the student's grade is entered. With the material scanned and saved, the original material can be returned to the student. Search and retrieval techniques may be employed, preferably using a web browser or appropriate secure client software, to allow controlled access to the images and related data in the database or document management system. Thus, the document images can be accessed remotely via the Internet. Preservation of the original material is thus of no further concern, since a virtual copy is retained in a secure form in the student's virtual subject folder file in the database.

Utilizing such a system a parent, guardian or administrator, provided with an appropriate identification key and security key, can access and view, preferably in a read only manner, an image of an original document, including the teacher or instructor's comments and grade thereon, as well as the student's original work product. The directory system in which the images are stored may be so organized and segmented to provide, for each student, a virtual “folder” by both grade and class, providing a centralized virtual repository for the student's work as well as a means for such materials to be reviewed in a secure and non-destructive manner by authorized parties. These virtual folders can be integrated with other materials and services of third party solution providers, such as scheduling, subject support, tutoring and the like for student, parent, guardian or administrator interfacing and activities.

In addition to providing the parent, guardian or administrator with controlled access thereto, the folders can be made available to the students themselves in order to assist the students to identify performance trends and to review the documents as study and teaching aids, such as in preparation for final exams, without the need for retaining the original materials. Periodically, such as at the end of a school year, all of a student's work can be transferred to additional or alternative media, such as a compact disk d, for archival storage and/or distribution.

### BRIEF DESCRIPTION OF THE DRAWING

A fuller understanding of the present invention will be accomplished upon consideration of the following description of a preferred, but nonetheless illustrative embodiment thereof, when reviewed in conjunction with the annexed drawing presenting a pictorial representation of the elements thereof.

### DETAILED DESCRIPTION OF THE INVENTION

As depicted in the FIGURE, the present invention provides an interactive education support system by providing a document archiving and retrieval system for student-related materials and documents, including homework, tests and other participatory material, particularly when such materials are graded and/or critiqued by a teacher. In accordance with generally recognized policies, each student is provided with an individualized identification number or code. Typically, this number may be the student's social security number, but it is to be appreciated that any individualized coding and identification format may be utilized. The identification number is provided and known to the student's teachers.

The teacher prepares an examination or other gradable/reviewable material or document, such as a test 10, for student use. The test or other material is disseminated in the normal manner, and retrieved and graded or otherwise evaluated or commented upon by the teacher by writing placed upon the returned material. Thus the present invention can be easily integrated into conventional classroom techniques and can be used with conventional teaching and examination/evaluation methods and materials. In addition to tests and the like, the present invention can also process worksheets and other documentary-type materials that form a written record of a student's participation in the educational process. The teacher can, in addition to grading the paper or test by assigning a grade thereto, mark and annotate the document in accordance with the teacher's and/or the school's requirements, policies, and/or needs and desires. In a similar manner, a worksheet or essay assignment, for example, can be critiqued in writing on the material itself.

While the reviewed/graded material remains in the teacher's possession, an optically recognizable identifier, such as a label 12, is affixed to the material. The label identifies the student by identification code, and may additionally provide other information, such as a class or course identifier, the teacher's name and/or identifying indicia relating to the nature of the particular document. This label may preferably be generated through class list data, and can be formed as part of a class-referenced label set 14. The teacher merely removes the appropriate label for the student and places it on the material. While it is preferred that the label 12 be placed upon the material 10 after the material is completed by the student and returned to the teacher to avoid mutilation, alteration or possible removal, labels can be placed on the materials before their dissemination. Alternatively, the identifying material can be printed, in whole or in part, directly on the disseminated material. In addition to an adhesively or otherwise affixable label, typically of paper, mylar or other similar sheet material, the optically recognizable identifier may be in the form of a designated portion of the material, such as an upper right hand corner of the first page thereof, with appropriate indicia forming an integral data entry “sheet” of form created as part of the material by a word processing program, for example, or may be otherwise preprinted thereon, or may be in the form of a stamping, embossment or the like applied to the material. All of the foregoing may be generally identified as a “label”.

Upon return, the teacher may at 16 also encode a grade directly on the label, such as by mark sense markings in a provided grade entry label area. While such direct encoding may facilitate the subsequent processing and retrieval of the grade by automated processing systems, it is also within the contemplation of the present invention that the grade be manually placed on the material or on the label in a conventional manner to be subsequently recognized through OCR or other methodologies.

The graded/encoded materials 16 are then electronically filed in the respective students “folders” maintained on the school's data processing system or network 22. Dedicated scanners and/or multi-function machines 20 having a scan function may be employed to convert paper documents to an image format and to process the encoded identification information on the material to identify the student and direct the scanned images to the appropriate folder. When the identifying information includes a class identifier, the images can be so routed and/or placed in the appropriate course sub-folder. Alternatively, at the time of scanning, particularly in a batch mode, additional data may be entered through a keypad at the input equipment to further direct the scanned images for storage, to validate the scan job for security reasons, and/or to associate or include additional information with the images.

In addition to or as an alternative to maintaining a folder file on the school network, the scanned images may be forwarded at 24, using appropriate transmission encryption and security, to a remote location or locations 26. Such remote locations may include, for example, the facility of third-party education support businesses for integration with other services provided. They may also be merely a remote Internet-enabled server facility to isolate the materials available for access and retrieval from the network 22.

Irrespective of the actual location of the stored materials, appropriate parties, such as the student's parents, teachers and administrators, as well as the student him- or herself, are provided with appropriate passwords to allow access to the stored materials. Internet access to the materials allows parents, for example, to access the materials at home, and to see a true and complete image of the original materials as presented and utilized by the student, including the student's own efforts with respect thereto and the grade and comments of the teacher. Preferably, such access is on a read-only basis, whereby the contents of a student's folder may be viewed, and downloaded as necessary, without compromising the integrity of the of the filed materials. Because the stored images are true copies of the original graded materials, including both the student's markings thereon as well as the teacher's comments and grade, the parent, in particular, is provided with a complete and unexpurgated copy of the document under review.

In addition to the parents being able to receive an accurate picture of the student's activities, the student him or herself may have access to the folder, which can be of particular benefit in reviewing for comprehensive exams and to assist the student in identifying performance trends. The student can download a copy and edit it as appropriate for further review or study without affecting the integrity of the original document. In addition, information retrieved from the documents can be placed into report form to allow summary reports to be generated. Captured grades may be integrated with a school district's electronic grade book, enabling teachers to avoid the manual entry of grades into a student's database.

The present invention further contemplates that other educational materials may be similarly captured and archived. For example, by the use of blackboard sensor technology as known, classwork 26 presented on a blackboard may be captured, printed and provided at 28 with identifying indicia, scanned if necessary, and stored. Such capture may be of particular benefit when the gradable material, such as a test, is in the form of an answer sheet that itself does not set forth the problems or questions, presented to the student on the blackboard, to which the answers are being recorded. The blackboard materials can be correlated and linked to the answer materials to allow both to be retrieved together.

By use of a plurality of fields and codes, each stored item can be cross indexed or referenced in a plurality of manners as appropriate, thus providing great flexibility in use thereof. The stored materials can also be transferred to alternative storage media, such as compact disk 32, either for archiving or distribution purposes. An appropriately prepared disk can serve, for example, as a record of a particular student's work for a given class, semester, year or other period, to be made available to the student. Other uses can similarly be envisioned, depending on the particular materials placed thereon.

I claim:

1. A method for establishing an interactive education support system in connection with a student identification database, comprising the steps of:
disseminating gradable material to at least one student for the student to enter gradable information thereon;
collecting the gradable material and determining a grade therefore;
entering teacher-generated review data for the student from whom the gradable material was collected upon the gradable material in a machine-readable format;
capturing and storing an image of the gradable material, including the review data, in an electronic folder associated with a student identification code thereon; and
providing controlled viewing access to the image by authorized viewers.

2. The method of claim 1 further including the steps of locating a label on the gradable material having a pre-determined data capture format for review data to be placed thereon and placing review data upon the label.

3. The method of claim 1 further including the step of locating a label on the gradable material having a specified location for the affixation of the student identification code.

4. The method of claim 2 or 3 wherein the step of locating a label comprises the affixation of a separate label to the gradable material.

5. The method of claim 2 wherein the review data includes a grade.

6. The method of claim 5 wherein the review data capture format accommodates the grade.

7. The method of claim 5 wherein the label includes a specified location for the affixation of the student identification code.

8. The method of claim 3 or 7 wherein the label includes a pre-printed student identification code.

9. The method of claim 1 further including the step of affixing the student identification code on the gradable material.

10. The method of claim 1, further including the step of returning the gradable material to the student after the image of the gradable material is stored.

11. The method of claim 3 or 7 wherein the identification code is entered on the gradable material after the gradable material is collected.

12. The method of claim 1 wherein the step of storing the image in an electronic folder includes a step of scanning the original gradable material to create an electronic image thereof.

13. The method of claim 1 wherein the step of providing viewing access is through the Internet.

14. The method of claim 1 wherein the grade is placed upon the gradable material in a machine-readable format.

15. The method of claim 8 further including the step of placing a captured grade in an electronic grade book or database.

16. The method of claim 1 further comprising the step of transferring at least one stored image from the electronic folder to a secondary storage media for dissemination.

17. The method of claim 16 wherein the secondary storage media is a cd.

18. The method of claim 17 wherein the transferring step comprises the transfer of a plurality of stored images associated with a particular student identification number.
